(19) United States
(12) Patent Application Publication
(10) Pub. No.: US 2002/0185073 A1
(43) Pub. Date: Dec. 12, 2002

(54) Animal feeding receptacle and food access impediments for slowing an animal's rate of eating

(76) Inventors: Wendy Fullerton, Tyro, VA (US); Diane McClure, Tyro, VA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 09/861,676

(22) Filed: May 22, 2001

(51) Int. Cl. A01K 1/10; A01K 5/00; A01K 39/00

(52) U.S. Cl. 119/51.01

(57) ABSTRACT

A food receptacle has a base and sidewall and, as a component or as a separate part, one or more impediments. The impediments are mounted on to the receptacle's base in order to provide a mechanical means to slow an animal's speed of eating once food has been dispensed into the receptacle. The impediment may have different shapes, and the impediment may be fixedly or slidingly mounted on to the base.

### FIELD OF THE INVENTION

This invention relates to feeding receptacles and food access impediments for animals.

### BACKGROUND OF THE INVENTION

Animal owners, animal breeders, animal health care professionals, animal researchers and others who have an interest in the health and well being of animals, and dogs in particular, have long been concerned about a potentially fatal medical problem called gastric dilatation-volvulus (GDV) or, in dogs, canine gastric dilatation-volvulus (CGDV), also known as “bloat.” Additionally, pet owners are routinely annoyed by flatulence or gas in their animals. Bloat risk and gas are of such concern that there are numerous websites devoted to GDV and to gas/flatulence.

A research program of risk factors for bloat in dogs, conducted by the Epidemiology Program Research Team of Purdue University's School of Veterinary Medicine at Purdue's West Lafayette, Ind. campus, has indicated that large and giant breed dogs with a history of belching or flatus are at a increased risk of bloat. Other veterinarians have also reported that belching and flatulence are considered to be potentially pre-bloat symptoms.

Purdue's GDV research began in September 1991 and included several national health surveys. These surveys showed GDV to be the second leading cause of death following cancer, in large (50-99 pounds) and giant (>99 pounds) breeds of dogs. However, because the results of these surveys were based on retrospective data, Purdue determined that a prospective study should be conducted to characterize the risk factors associated with bloat. The five-year prospective study began in 1994. Study findings identified risk factors associated with CGDV and a method, using these risk factors, for calculating a dog's lifetime risk of GDV. For both large and giant breeds (in other words, all dogs weighing 50 pounds or more), four risk factors were identified: age, chest depth/width ratio, first degree relative with GDV and eating from a raised food bowl. For large breed dogs, i.e., 50 to 99 pounds, a fifth factor, speed of eating, was identified. Indeed, eating speed as a precipitating factor in GDV was considered of sufficient significance that the research team, in its April 1996 “Bloat Notes” publication, included the following request:

Wanted—Speed limit! How do you slow down a fast eater?? If you have found a practical method to slow your dog's rate of eating, we would like to hear about it. Also, please let us know if it is OK to publish your idea in a future issue of BLOAT NOTES. Write to: Diane Schellenberg, Bloat Research, VPTI 101, Purdue University School of Veterinary Medicine, West Lafayette Ind. 47907-1243.

The single anomaly in the Purdue research was that speed of eating was not a bloat risk factor in giant dog breeds. While the Purdue study was limited to large and giant breeds, other information indicates that GDV has been reported in smaller dogs such as the Pekingese, Dachshund, and English Bulldog. Gastric dilatation also has been seen in domestic cats, foxes, mink, wild carnivores, rabbits, nutria, guinea pigs, rats, mice and monkeys.

Regardless of whether or not a relationship exists between gas and GDV, both are problems. Gas, particularly flatulence which can be “so foul and offensive that people gag and run out of the room,” is an annoyance for most pet owners at one time or another irrespective of the animal's size and, for other pet owners, a nearly continuous annoyance. GDV, if not treated as a dire medical emergency, is usually fatal. Even when treated with immediate emergency care, GDV may still cause permanent harm to the animal's gastric system, which, in turn, increases the probability of future GDV attacks, unless gastroplexy, a surgical procedure is performed.

The literature for addressing both gas and GDV includes several overlapping recommendations for prevention. A summary of prevention procedures is presented below:

| Procedure Category | Gas | GDV |
|---|---|---|
| Mechanical | Prevent the animal from | Prevent the animal from |
| | swallowing or eating air, a | swallowing or eating air, a |
| | behavior known as aerophagia | behavior known as aerophagia |
| | that occurs when an animal | that occurs when an animal eats |
| | eats too fast | too fast |
| Bio-chemical | 1. Administer various over- | 1. Administer various over-the- |
| | the-counter preparations such | counter preparations such as |
| | as antacids, activated | antacids, activated charcoal or |
| | charcoal or other products | other products manufactured |
| | manufactured specifically for | specifically for pets, e. g., |
| | pets, e. g., Curtail ™ | Curtail ™ |
| | 2. Change the animal's diet | 2. Change the animal's diet |
| | | 3. Increase gastric transit via a |
| | | pro-kinetic agent such as B- |
| | | Guard ™, a prescription |
| | | medication made of sub- |
| | | therapeutic doses of erythromycin |
| | | combined with a commercial |
| | | grade, high-viscosity soluble fiber, |
| | | B-Guard is not effective for dogs |
| | | with stomach muscles and nerves |
| | | damaged by bloat or other |
| | | disorders. Certain other medical |
| | | disorders, e. g., hypothyroidism, |
| | | must be corrected before use of B- |
| | | Guard. |
| Surgical | | Gastroplexy |

With the Mechanical Procedures, the following suggestions have been made to prevent or minimize aerophagia, behavior characterized by swallowing air when food is gulped.

1. Feed several small meals a day rather than one large meal to reduce the amount of air swallowed at one feeding. This suggestion is inconvenient and cannot be carried out on a consistent basis as it requires owners either to stay at home throughout every day to provide the small meals, to interrupt activities, e.g., work, to return home to feed the animal, or to hire someone to perform the feeding.

2. Minimize stress or excitement at feeding time. This suggestion is impractical as excitement at feeding time is one of the characteristics of enthusiastic or “greedy” eaters.

3. Isolate “greedy” eaters at feeding time to minimize competition when multiple pets or animals are co-located. This suggestion is impractical if there are more than two animals to be fed as separate spaces capable of affording isolation may not be available. If multiple isolation areas are not available, then it is necessary to stagger feeding times, using scheduling as the means of isolation rather than physical space. Isolation via scheduling presents the same problems as feeding several small meals each day. Additionally, isolating an animal not otherwise isolated has the potential to introduce stress at feeding time, which is to be avoided.

4. Place rocks or tennis balls, in the food receptacle to increase the time the animal takes to access and, thereby, eat its food. To be safe for inclusion with food in a food receptacle, the rocks need to be carefully inspected to ensure they are free of fractures (that would result in breakage, followed by ingestion and internal injury) and rough or sharp edges (that would result in lacerations to lips, gums and tongue or damage to the animal's teeth). Additionally, rocks must be of sufficient size to prevent outright ingestion with kibble and to discourage the animal from removing the rocks from the food receptacle. Rocks also must be of sufficient smoothness to ensure ease of cleaning after meals. Tennis balls, on the other hand, are easily removed by even small animals and are extremely difficult to adequately clean. The nap on tennis balls, once dampened by the mixture of food and animal saliva, quickly becomes a breeding ground for a variety of harmful bacteria, as well as bits of fermented food which in itself can result in digestive distress.

### SUMMARY OF THE INVENTION

In accordance with the present invention a food receptacle comprises a base and sidewall and, as a component or as a separate device, one or a plurality of impediments. The impediments are fixedly mounted to the receptacle's base, slidingly mounted to the receptacle's base, removable as a separate modular unit, or fixedly or slidingly mounted to a base insert or integrally molded or stamped as a continuous feature of the insert base. In addition to the attributes described elsewhere in this patent, several objects and advantages of the present invention are:

1. To provide a mechanical means to slow an animal's speed of eating once the food has been dispensed into the food receptacle;

2. To provide a non-chemical and natural method to reduce or eliminate belching and flatulence in animals;

3. To provide a non-chemical and natural method to mediate the speed of eating GDV risk factor;

4. To eliminate the aggravation associated with isolating “greedy eaters” so as to reduce competition in settings where co-located animals are fed simultaneously;

5. To provide impediments in the receptacle that can not be easily removed by the animal;

6. To provide impediments having the purpose of minimizing harm to the animal's external and internal oral area and teeth;

7. To provide impediments that are of a size that cannot be swallowed or ingested with the food;

8. To provide a food receptacle wall-to-bottom angle that slows speed of eating and that, simultaneously, prevents the animal from tipping over the receptacle;

9. To reduce the need to modify or change completely an animal's diet when flatulence and/or belching is a result of swallowing air while gulping food;

10. To provide means to change animal eating behaviors, e.g., train an animal to eat more slowly;

11. To provide ease of cleaning;

12. To raise animal owner's awareness of the potential hazards of an animal's eating speed;

13. To provide animal owner with “no-stress” method for dealing with animals that eat too fast; and

14. To provide an easily understood method for slowing an animal's eating speed.

### BRIEF DESCRIPTION OF THE DRAWINGS

FIG. 1 is a perspective view of one embodiment of the animal feeding receptacle invention.

FIG. 2 is a side elevation, cross sectional view of the receptacle shown in FIG. 1.

FIG. 3 is a top elevation view of the animal feeding receptacle shown in FIG. 1.

FIG. 4 is a perspective view of an alternative embodiment of an animal feeding receptacle in accordance with the present invention.

FIG. 5 is an exploded, perspective view of a further embodiment of the animal feeding receptacle invention.

FIG. 6 is a perspective view of a still further embodiment of the present animal feeding receptacle invention.

FIG. 7 is a perspective view of a still further embodiment of the present animal feeding receptacle invention.

FIG. 8 is a perspective view of an impediment in accordance with the present invention.

FIG. 9 is a perspective view of an alternative embodiment of an impediment in accordance with the present invention.

FIG. 10 is a perspective view of a still further embodiment of an impediment in accordance with the present invention.

### DETAILED DESCRIPTION OF THE PREFERRED EMBODIMENTS

The invention is a food receptacle and one or a plurality of impediments to slow an animal's access to food. This invention is contrary to prior art teachings that reflect the conventional thinking that animal food receptacles should provide easy access to the food, thus encouraging animals to consume meals within a brief period of time. In fact, much advice has been given to pet owners regarding how to speed the eating rate of dogs that dawdle at the food bowl.

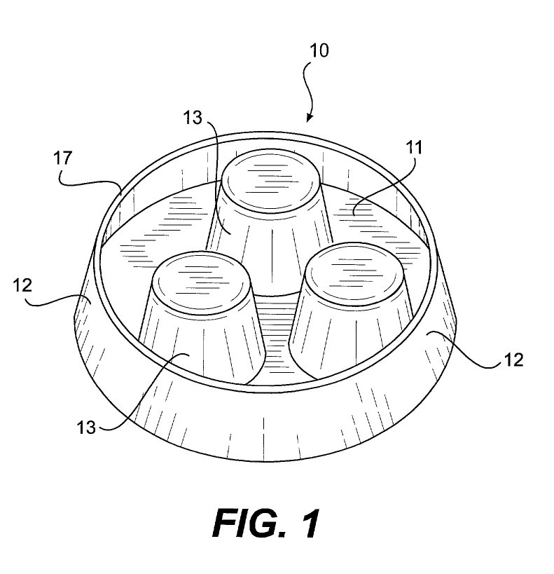

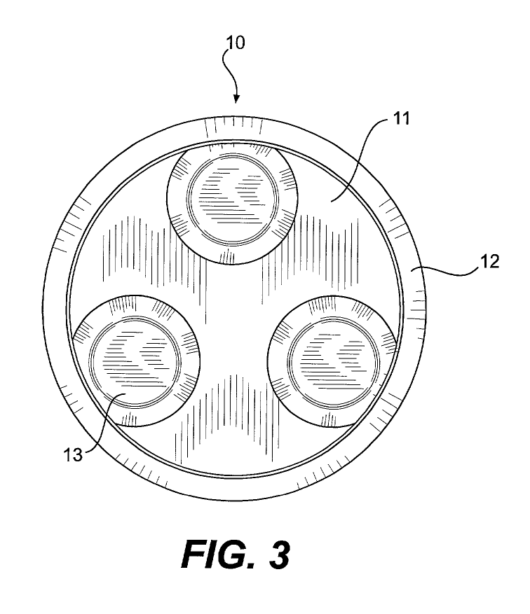

FIGS. 1, 2, and 3—Food Receptacle

A preferred embodiment of the present invention is illustrated in FIGS. 1 through 3. An animal feeding receptacle 10 is shown. The edges 17 of food receptacle 10 are rounded, curved or beveled to prevent harm to the animal's external and internal oral area and the animal's teeth. The food receptacle 10 may be formed of smooth metal, ceramic, porcelain or any other material having properties that make it suitable for coming into contact with food and the animal's external and internal oral area and teeth, that facilitate cleaning, and that is minimally susceptible to being chipped, broken or fragmented.

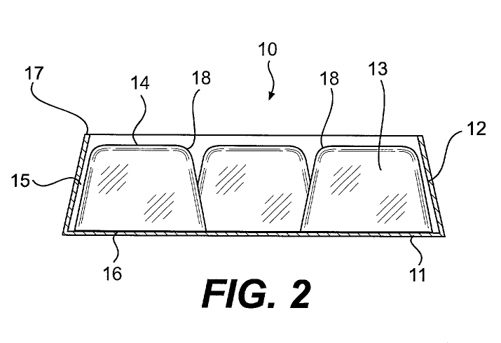

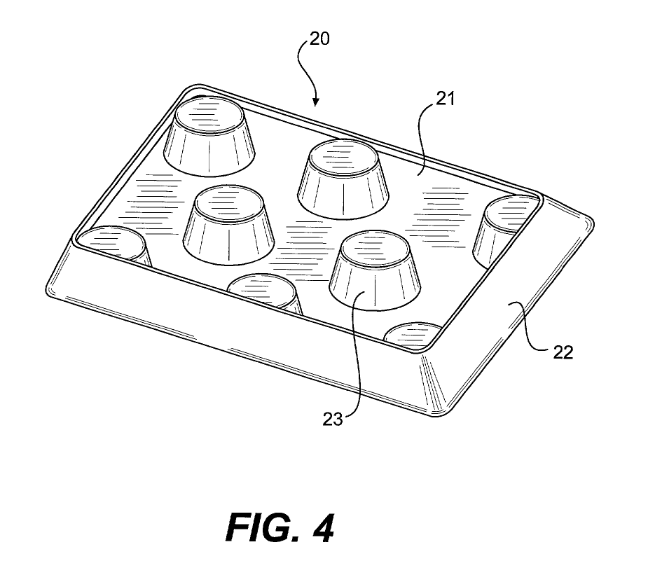

The base 11 of food receptacle 10 is connected all around to a sidewall 12 thus forming an opening. As shown best in FIG. 2, the angle formed by the base 11 and sidewall 12 is an acute angle, preferably in the range of 45° to 85°. The acute angle helps prevent tipping of the food receptacle 10 and further reduces ease of access by an animal to the receptacle's contents and hinders the animal from picking up the receptacle with its teeth. The overall size of the food receptacle 10 is of sufficient capacity to accommodate the intended quantity of its contents. For instance, it is common for larger dogs to eat from a 2-quart bowl, but any size is possible depending on the animal. The shape of food receptacle 10 is round. Alternative embodiments include geometrical shapes such as oval, hexagonal, square or rectangular as with food receptacle 20 shown in FIG. 4. In FIG. 4, the receptacle 20 is made up of a base 21, sidewalls 22 and includes impediments 23.

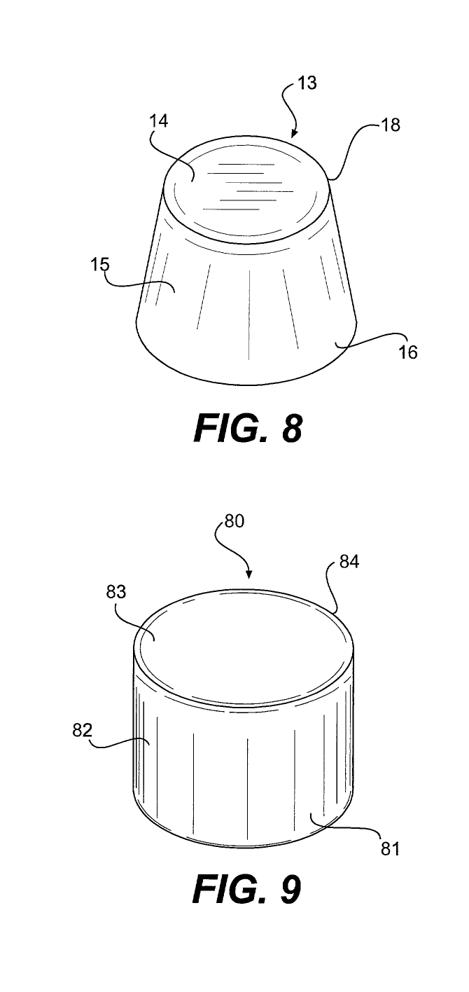

FIG. 8—Impediment Preferred Embodiment

FIG. 8 shows a preferred embodiment of the impediment 13. One or a plurality of impediments 13 are placed in the receptacle 10. The number of impediments 13 placed in the food receptacle 10 is dependent on the animal's enthusiasm for food. The impediments 13 are fruscoconically-shaped. The impediment top 14 and the impediment base 16 are both circular and are connected around by impediment sidewall 15. The angle defined by the impediment sidewall 15 and the impediment base 16 is an acute angle. In the preferred embodiment shown, the acute angle defined by the impediment base 16 and sidewall 15 is the same acute angle as defined by the receptacle base 11 and sidewall 12. (See FIG. 2).

The overall size of the impediment is proportionate to the size of the intended food receptacle and the number of impediments intended for placement into the food receptacle. The height of impediment 13 is preferably sufficient to rise above the level of food placed in the food receptacle.

The edges 18 of impediment 13 are rounded, curved or beveled to prevent harm to the animal's external or internal oral area and the animal's teeth. The impediment may be formed of smooth metal, ceramic, porcelain or any other material having properties that make it suitable for coming into contact with food and the animal's external and internal area and teeth, that facilitate cleaning, and that is minimally susceptible to being chipped, broken or fragmented.

The impediment 13 mounted on the base 11 is not attached in any way to the base, so it may easily be added to or removed from the receptacle 10. The impediment 13 is capable of sliding freely around on the food receptacle base 11 as the animal feeds. The fruscoconical shape of the impediment 13 offers the advantage of making it difficult to be removed or tipped over by the feeding animal. The removable (by the animal care provider) nature of the impediment 13 provides the advantage of allowing its use in any food receptacle having a base of sufficient area to accommodate one or a plurality of the impediments.

Alternatively, the impediment 13 may be fixedly mounted to base 11 of food receptacle 10. The impediment 13 may be welded, glued, nailed, screwed, etc. to fix it to the base 11. If impediment 13 is used in its removable form, its base may be weighted to increase the difficulty of its removal by the animal from the food receptacle. Alternatively, a magnet (not shown) may be fixedly mounted onto or inside the impediment 13 to increase the animal's difficulty in removing the impediment from metal food receptacles. The impediment 13 itself may be magnetic. Still further, one or a plurality of magnets may be mounted to the underside of the base 11 of food receptacle 10 for use with metal impediments.

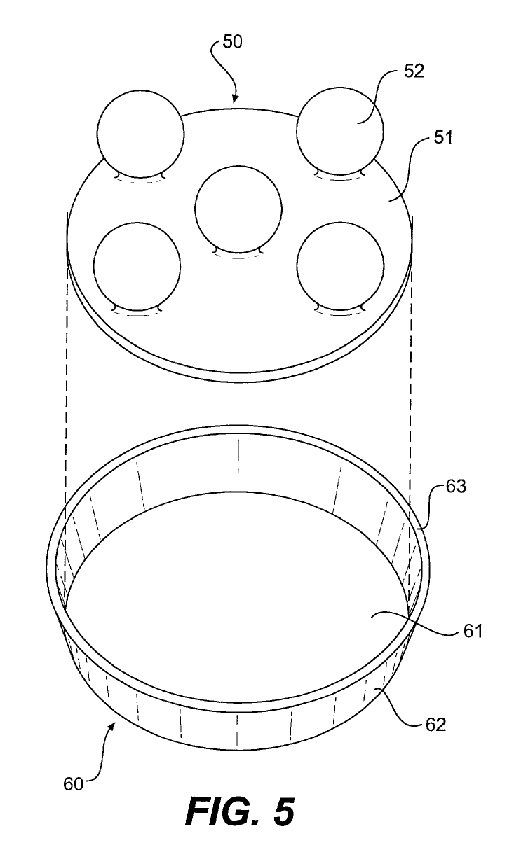

FIG. 5—Base-Mounted Impediment Insert

An alternative embodiment of the invention is shown in FIG. 5 wherein the angle defined by the base 61 and sidewall 62 of the food receptacle 60 may be acute, obtuse or a right angle. The only limitation is that the diameters of both base 61 and the opening formed by the top edge 63 of the sidewall 62 of food receptacle 60 be of sufficient size to accommodate the diameter of the base 51 of the impediment insert 50. The base mounted impediment insert 50 comprises a base 51 and impediments 52. The impediments 52 shown in FIG. 5 are mushroom or knob shaped but may be fruscoconically or cylindrical in shape and may be fixedly mounted to base 51 or may be mounted in such a way, for example on a post, as to be removable. Alternatively, the base 51 and impediments 52 that make up the insert 50 may be molded or stamped as a single unit out of a single piece of material at which point the impediments become immovable projections extending upward from the base of the insert. The number of impediments may range from one to a plurality. Further, the insert 50 may be fixed in a food receptacle or removably mounted or a slidable insert.

The base-mounted impediment insert 50 may be formed of smooth metal, ceramic, porcelain, plastic or any other material having properties that make it suitable for coming into contact with food and the animal's external and internal oral area and teeth, that facilitate cleaning, and that is minimally susceptible to being chipped, broken or fragmented.

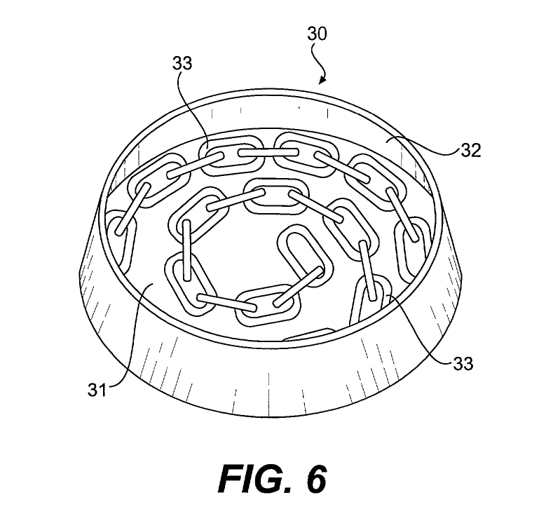

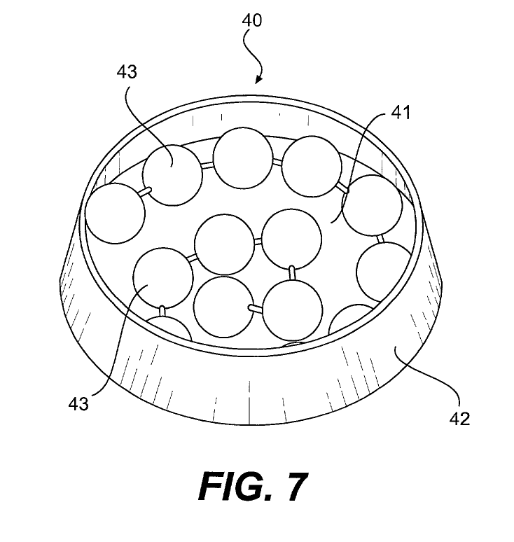

FIGS. 6 and 7—Alternatively Shaped Impediment Embodiment

The shape, angles and materials of food receptacle 30 in FIG. 6 and food receptacle 40 shown in FIG. 7 are the same as that described for food receptacle 10 shown in FIGS. 1, 2 and 3 and described above although any shaped food receptacle is sufficient. Bases 31 and 41 and sidewalls 32 and 42 are the same as base 11 and sidewall 12. FIG. 6 shows a link chain impediment 33 that is an alternative embodiment to the fruscoconically-shaped impediment shown in FIGS. 1,2,3 and 8 and described above. FIG. 7 shows a bead chain impediment 43. Both the chain link impediment 33 and the bead chain impediment 43 have edges that are rounded, curved or beveled to prevent harm to the animal's external or internal oral area and the animal's teeth. Both the chain link impediment 33 and the bead link impediment 43 may be formed of smooth metal, ceramic, porcelain, plastic or any other material having properties that make it suitable for coming into contact with food and the animal's external and internal oral area and teeth, that facilitate cleaning, and that is minimally susceptible to being chipped, broken or fragmented.

If made of metal, the chain 33 or 43 may be magnetized to restrict ease of removal by the feeding animal. Regardless of the material used for the link chain 33 and bead chain 43, the weight of the material should be such to discourage the impediment's removal from the food receptacle. Alternatively, the link chain 33 and bead chain 43 impediments may be attachable to the base of the food receptacle. The number of chain links and bead links is of sufficient quantity to impede ease of access to food in the receptacle.

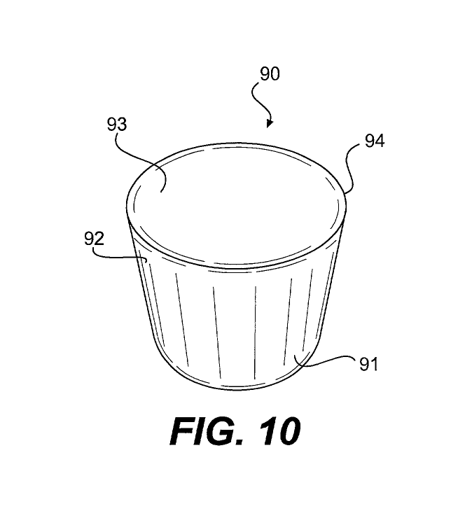

FIGS. 9 and 10—Alternatively Shaped Impediment Embodiments

FIG. 9 shows a cylindrically-shaped impediment 80 wherein the base 81 and the top 83 are of equal diameter and are connected around by sidewall 82. The edges 84 of impediment 80 are rounded, curved or beveled to prevent harm to the animal's external or internal oral area and the animal's teeth. The impediment may be formed of smooth metal, ceramic, porcelain or any other material having properties that make it suitable for coming into contact with food and the animal's external and internal oral area and teeth, that facilitate cleaning, and that is minimally susceptible to being chipped, broken or fragmented.

As the cylindrical shape of impediment 80 makes it more susceptible to tipping and then removal by the feeding animal, impediment 80 is more functional if fixedly mounted to the food receptacle into which it is placed. Alternatively, impediment 80 may be placed in the food receptacle with sidewall 82 in contact with the base of the food receptacle. This position will make it easier to remove by the feeding animal, however this disadvantage can be mediated by positioning one or a plurality of magnets inside the impediment 80 and using the impediment in a metal food receptacle. Alternatively, one or a plurality of magnets may be mounted to the underside of the food receptacle for use with metal impediments.

FIG. 10 demonstrates an inverted fruscoconically-shaped impediment 90 having a base 91 and top 93 connected by sidewalls 92. In this embodiment, the impediment 90 is inverted as compared to the impediment 13 discussed in connection with earlier embodiments. The edges 94 of the impediment 90 are rounded, curved or beveled to prevent harm to the animal's external or internal oral area and the animal's teeth.

As used throughout this description, an impediment is an upward projection from the base of a feeding receptacle that is adapted to slow an animal's eating. The impediment may be any shape that can be upwardly projecting from the base of a receptacle, but it must not be so small or so rough as to be easily grasped by an animal's mouth. In the event that the object chosen to be an impediment may be gripped by an animal, it is essential that the impediment be anchored or fixed in some fashion to the base of the receptacle. The available shapes for an impediment in accordance with the present invention are many. For instance, the frusconconical shape illustrated has straight sidewalls. Alternatively, the sidewalls of a frusconconical shape may be curved to form a more bullet or cone-shaped frusconconical object.

Accordingly, the reader will see that the food receptacle and the impediments, whether the food receptacle and impediments are used together or the impediments are used alone with an existing receptacle, serve the need of slowing an animal's speed of eating, thereby reducing the amount of air swallowed and, in turn, reducing the consequent amount of gas in the gastroenteric system without the need to resort to chemicals whose means of action is via ingestion. Reducing the quantity of gastroenteric system gas has been demonstrated to reduce annoying belching and flatulence in animals and to reduce risks for GDV, a life threatening animal emergency.

Although the description above contains many specifics, these should not be construed as limiting the scope of the invention but as merely providing illustrations of some of the presently preferred embodiments of this invention. For example, the food access impediments can have other shapes such as round, knobby, conical, etc.; the food access impediments can be permanently attached to the receptacle, movable or removable; the number of food access impediments can vary; the placement and configuration of the food access impediments can vary in terms of space between impediments, space between the impediments and receptacle's walls; and the overall size and geometric shape of the receptacle can vary.

Thus the scope of the invention should be determined by the appended claims and their legal equivalents, rather than by the examples given.

What is claimed is:

1. An animal feeding receptacle comprising:
a base and a sidewall connected around the base adapted to form an open receptacle, and an impediment mounted onto the base of the receptacle and extending upwardly therefrom.

2. The animal feeding receptacle described in claim 1, wherein the impediment is fixedly mounted onto the base.

3. The animal feeding receptacle described in claim 1, wherein the impediment is slidingly mounted onto the base.

4. The animal feeding receptacle described in claim 1, wherein the impediment is fruscoconically-shaped.

5. The animal feeding receptacle described in claim 2, wherein the impediment is mushroom-shaped.

6. The animal feeding receptacle described in claim 1, wherein the impediment is a chain.

7. The animal feeding receptacle described in claim 6, wherein the chain is a bead chain.

8. The animal feeding receptacle described in claim 1, wherein the sidewall forms an acute angle with the base.

9. The animal feeding receptacle described in claim 8, wherein the impediment is fruscoconically-shaped.

10. The animal feeding receptacle described in claim 9, wherein the angle defined by the receptacle sidewall and base is substantially the same as the angle defined by a bottom and sidewall of the impediment.

11. The animal feeding receptacle described in claim 1, further comprising a plurality of impediments.

12. An insert for an animal feeding receptacle wherein the receptacle comprises a first base and a sidewall connected around the first base adapted to form an open receptacle, the insert comprising:
a second base comprising an impediment mounted on one side thereof and that extends outwardly therefrom, and
wherein the second base is adapted to be mounted on the first base.

13. An insert for an animal feeding receptacle as described in claim 12, wherein the second base is removably mounted on the first base.

14. An insert for an animal feeding receptacle as described in claim 12, wherein the second base is fixedly mounted on the first base.

15. An insert for an animal feeding receptacle as described in claim 12, wherein the second base is slidingly mounted on the first base.

16. An insert for an animal feeding receptacle as described in claim 12, wherein the impediment is fruscoconically-shaped.

17. An insert for an animal feeding receptacle as described in claim 12, wherein the impediment is mushroom-shaped.

18. An insert for an animal feeding receptacle as described in claim 12, further comprising a plurality of impediments mounted on the second base.

19. An impediment adapted to be mounted in an animal feeding receptacle wherein the receptacle comprises a base and a sidewall connected around the base, and wherein the impediment is a projection adapted to be mounted onto the base and extend upwardly therefrom.

20. An impediment adapted to be mounted in an animal feeding receptacle as described in claim 19, further wherein the impediment is adapted to be fixedly mounted onto the base.

21. An impediment adapted to be mounted in an animal feeding receptacle as described in claim 19, further wherein the impediment has a fruscoconical shape.
